(19) United States
(12) Patent Application Publication
(10) Pub. No.: US 2016/0290490 A1
(43) Pub. Date: Oct. 6, 2016

(54) 4-Point Convex Contact Roller Bearing For Compact Planetary Drive Train

(71) Applicant: NORTHEASTERN UNIVERSITY, Boston, MA (US)

(72) Inventors: Elias Brassitos, Boston, MA (US); Constantinos Mavroidis, Arlington, MA (US); Quingchao Kong, Boston, MA (US)

(21) Appl. No.: 15/037,991

(22) PCT Filed: Dec. 8, 2014
(86) PCT No.: PCT/US14/69081

§ 371 Date: May 19, 2016

Related U.S. Application Data
(60) Provisional application No. 61/913,635, filed on Dec. 9, 2013.

(51) Int. Cl. F16H 57/08; F16H 1/28

(52) U.S. Cl. CPC F16H 57/08; F16H 1/28; F16H 2057/085

(57) ABSTRACT

The present disclosure provides a gear set. The gear set includes a ring gear including a plurality of ring gear teeth on an inner radial edge of the ring gear and an arcuate ring roller positioned axially outward of the ring gear teeth. The gear set includes a sun gear having a plurality of sun gear teeth positioned about an outer radial sun gear edge and an arcuate sun gear roller positioned axially outward of the sun gear teeth. The gear set includes a planetary gear positioned in the ring gear between the sun gear and the ring gear. The planetary gear includes a plurality of planetary gear teeth positioned about an outer radial planetary gear edge. The plurality of planetary gear teeth engage the sun gear teeth and the ring gear teeth. The planetary gear includes an arcuate planetary gear roller positioned axially outward of the planetary gear teeth. The arcuate planetary gear roller engages the arcuate ring roller and the arcuate sun gear roller.

### CROSS-REFERENCE TO RELATED APPLICATION

The present application claims priority to U.S. Provisional Patent Application No. 61/913,635, filed Dec. 9, 2013 and entitled “4-POINT CONVEX CONTACT ROLLER BEARING FOR COMPACT PLANETARY DRIVE TRAIN,” which application is incorporated herein by reference in its entirety.

### TECHNICAL FIELD

The present application relates generally to the field of gear sets. More specifically, the present application relates to planetary gear sets or epicyclic gear sets.

### BACKGROUND

There is a growing demand for advanced compact actuators. Such actuators may be implemented in robotics, nanotechnology, biotechnology, miniaturized devices and instruments, or other systems that need to apply substantial forces. The demand for small lightweight devices able to apply large forces, develop high speeds, achieve large displacements, and be highly energy efficient has increased the demand for high performance and efficient powertrains.

One type of powertrain associated with actuators includes planetary gear sets. Planetary gear sets generally include complex ball bearing arrangements facilitating rotation between the gear components of the planetary gear set. Planetary gear sets also generally include planetary gear carriers configured to maintain the rotation and alignment of the planetary gears. While the complex ball bearing arrangements reduce friction and contribute to smooth operation, the ball bearing arrangements add significant weight to the planetary gear set and increase the difficulty of manufacturing the planetary gear set. Similarly, the planetary gear carries increase complexity and weight of planetary gear sets.

### SUMMARY

The inventors have appreciated that a gear set assembly configured for point contact may be provided to simplify the complexity of the gear set assembly and provide a highly efficient and precise gear set assembly.

Accordingly various exemplary embodiments provide a gear set assembly including a ring gear including a plurality of ring gear teeth on an inner radial edge of the ring gear. The ring gear includes a first arcuate ring roller and a second arcuate ring roller. The first arcuate ring roller and the second arcuate ring roller are positioned axially outward of the ring gear teeth on opposite lateral sides of the ring gear. The gear set assembly includes a sun gear having a plurality of sun gear teeth positioned about an outer radial sun gear edge. The sun gear includes a first arcuate sun gear roller and a second arcuate sun gear roller. The first arcuate sun gear roller and the second arcuate sun gear roller are positioned axially outward of the sun gear teeth on opposite lateral sides of the sun gear. The gear set assembly also includes a planetary gear positioned in the ring gear between the sun gear and the ring gear. The planetary gear includes a plurality of planetary gear teeth positioned about an outer radial planetary gear edge. The plurality of planetary gear teeth engage the sun gear teeth and the ring gear teeth. The planetary gear includes a first arcuate planetary gear roller and a second arcuate planetary gear roller. The first arcuate planetary gear roller and the second arcuate planetary gear roller are positioned axially outward of the planetary gear teeth on opposite lateral sides of the planetary gear. The first arcuate planetary gear roller engages the first arcuate ring roller and the first arcuate sun gear roller and the second arcuate planetary gear roller engages the second arcuate ring roller and the second arcuate sun gear roller.

In particular embodiments, the arcuate ring roller has a ring roller radius that is larger than the arcuate planetary gear roller. The planetary gear includes a first planetary gear and a second planetary gear, in accordance with particular embodiments. The gear set assembly may include a sensor, such as a compliant torque sensor coupled to the gear set assembly and configured to measure torque applied to one or more gears. In particular embodiments, the gear set assembly includes a motor coupled to the sun gear. The first and second arcuate ring rollers may be integrally formed with the ring gear the first. The second arcuate sun gear rollers may be integrally formed with the sun gear. The first and second planetary gear rollers may be integrally formed with the planetary gear. In particular embodiments, the first and second arcuate ring rollers, the first and second arcuate sun gear rollers, and the first and second planetary gear rollers are parallel to another.

Particular embodiments provide a gear set assembly including a ring gear including a plurality of ring gear teeth on an inner radial edge of the ring gear. The ring gear includes an arcuate ring roller positioned axially outward of the ring gear teeth. The sun gear has a plurality of sun gear teeth positioned about an outer radial sun gear edge. The sun gear includes an arcuate sun gear roller positioned axially outward of the sun gear teeth. The planetary gear is positioned in the ring gear between the sun gear and the ring gear. The planetary gear includes a plurality of planetary gear teeth positioned about an outer radial planetary gear edge. The plurality of planetary gear teeth engage the sun gear teeth and the ring gear teeth. The planetary gear including an arcuate planetary gear roller positioned axially outward of the planetary gear teeth. The arcuate planetary gear roller engages the arcuate ring roller and the arcuate sun gear roller.

In particular embodiments, the gear set includes a motor coupled to the sun gear. The gear set includes a compliant torque sensor coupled to the gear set assembly and configured to measure torque applied to one or more gears.

Particular embodiments provide a method of forming a gear set. The method includes coupling an arcuate ring roller to a ring gear. The ring gear includes a plurality of ring gear teeth on an inner radial edge of the ring gear. The arcuate ring roller is positioned axially outward of the ring gear teeth. The method includes coupling an arcuate sun gear roller to a sun gear. The sun gear has a plurality of sun gear teeth positioned about an outer radial sun gear edge. The arcuate sun gear roller is positioned axially outward of the sun gear teeth. The method includes coupling an arcuate planetary gear roller to a planetary gear. The planetary gear includes a plurality of planetary gear teeth positioned about an outer radial planetary gear edge. The arcuate planetary gear roller is positioned axially outward of the planetary gear teeth. The method also includes coupling the sun gear to the ring gear via the planetary gear. The planetary gear is positioned in the ring gear between the sun gear and the ring gear. The plurality of planetary gear teeth engage the sun gear teeth and the ring gear teeth. The arcuate planetary gear roller engages the arcuate ring roller and the arcuate sun gear roller.

In particular embodiments, the method includes the ring gear includes a first ring gear. The sun gear includes a first sun gear. The plurality of planetary gears includes a first plurality of planetary gears. The method also includes coupling a second ring gear to the first ring gear, coupling a second sun gear to the first sun gear, and coupling a second plurality of planetary gears to the first plurality of planetary gears so as to form a two stage planetary gear set.

The method may include positioning a first ball bearing in a ball bearing race between the first ring gear and the second ring gear. The method may include positioning a first ball bearing in a ball bearing race between the first sun gear and the second sun gear. In particular embodiments, the method includes coupling a motor to the sun gear. The method includes coupling a compliant torque sensor to the gear set assembly in accordance with particular embodiments.

Various particular embodiments provide a method of forming a gear set that includes coupling a sun gear to a ring gear via a plurality of planetary gears. The plurality of planetary gears is positioned between the sun gear and the ring gear. The plurality of planetary gears engages the sun gear and the ring gear. The method includes coupling a first arcuate ring roller and a second arcuate ring roller to the ring gear on a first ring gear axial face and second ring gear axial face respectively. The method includes coupling a first arcuate sun gear roller and a second arcuate sun gear roller to the sun gear on a first sun gear axial face and a second sun gear axial face respectively. The method also includes after the first arcuate ring roller and the second arcuate ring roller are coupled to the ring gear and after the first arcuate sun gear roller and the second arcuate sun gear roller are coupled to the sun gear, coupling the plurality of first arcuate planetary rollers and the plurality of second arcuate planetary rollers to the plurality of planetary gears on a first planetary gear axial face of each planetary gear in the plurality of planetary gears and on a second planetary gear axial face of each planetary gear in the plurality of planetary gears.

In particular embodiments, the first arcuate ring roller, the second arcuate ring roller, the first arcuate sun gear roller, and the second arcuate sun gear roller have a radial ring roller radius that is larger than the plurality of first arcuate planetary rollers and the plurality of second arcuate planetary rollers. The method includes coupling a motor to the sun gear, in accordance with particular embodiments. The method may include coupling a compliant torque sensor to the gear set assembly, where the compliant torque sensor is configured to measure a torque applied to one or more gears. In particular embodiments, the ring gear includes a first ring gear and the sun gear includes a first sun gear. The plurality of planetary gears includes a first plurality of planetary gears. The method also includes coupling a second ring gear to the first ring gear, coupling a second sun gear to the first sun gear, and coupling a second plurality of planetary gears to the first plurality of planetary gears so as to form a two stage planetary gear set.

The inventors have appreciated that gear set assemblies may be provided that permit low and high speed reduction efficiently, maintain gear-set alignment using significantly reduced ball bearings and planet carriers, thereby simplifying the assembly process and reducing the costs of production.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a partially cross sectional end view of a two stage planetary gear set, in accordance with exemplary inventive embodiments.

FIG. 2 is a schematic of the contact surfaces of a planetary gear set, in accordance with exemplary inventive embodiments.

FIG. 3 is a cross sectional schematic of a two stage planetary gear set, in accordance with exemplary inventive embodiments.

FIGS. 4A and 4B are cross sectional views of a planetary gear bearing drive, of a two stage planetary gear set, in accordance with exemplary inventive embodiments.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive gear set assembly and methods of implementing and manufacturing gear set assemblies. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

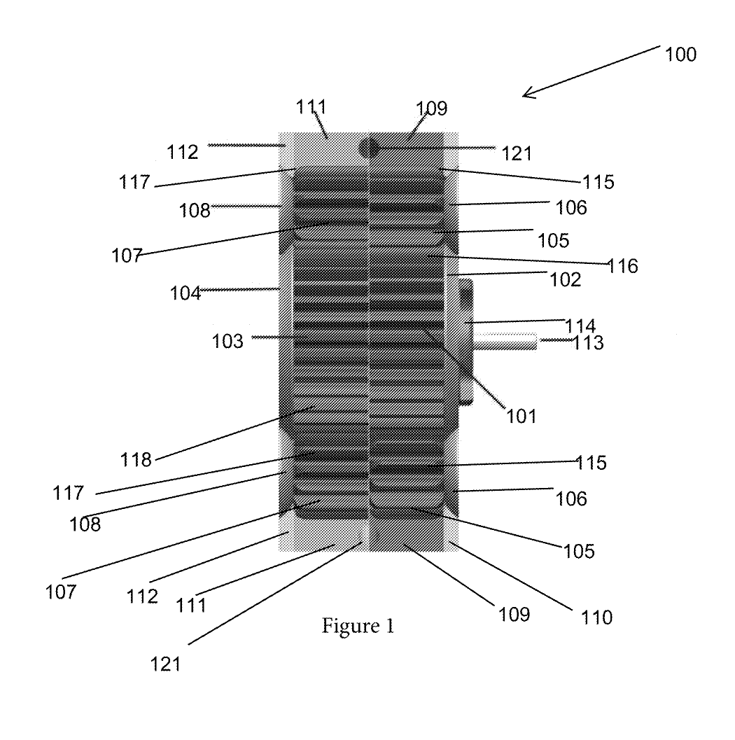

FIG. 1 is a partially cross sectional end view of a two stage planetary gear set, in accordance with exemplary inventive embodiments. A planetary gear set assembly is illustrated in the FIG. 1 integrated with a motor 114 to form gearing bearing drive 100. The planetary gear set assembly illustrated in FIG. 1 is a two stage planetary gear set including an input sun gear 101, an output sun gear 103, an input stage ring 109, an output stage ring gear 111, a plurality of first stage planetary gears 105, and a plurality of second stage planetary gears 107. The input stage ring gear 109 and the output stage ring gear 111 houses the input sun gear 101, the output sun gear 103, the first stage planetary gears 105 and the second stage planetary gears 107. The first stage planetary gears 105 engage the input sun gear 101 via the first stage planetary gear teeth 115 of the first stage planetary gears 105 and the input sun gear teeth 116 of the input sun gear 101. The input sun gear teeth 116 are positioned about an outer radial edge of the input sun gear 101. The first stage planetary gear teeth 115 are positioned about an outer radial edge of the first stage planetary gears 105. Similarly, the second stage planetary gears 107 engage the output sun gear 103 via the second stage planetary gear teeth 117 of the second stage planetary gears 107 and the output sun gear teeth 118 of the output sun gear 103. The output sun gear teeth 118 are positioned about an outer radial edge of the output sun gear 103. The second stage planetary gear teeth 117 are positioned about an outer radial edge of the second stage planetary gears 107.

The input stage ring gear 109 and the output stage ring gear 111 are coupled to the input sun gear 101 and the output sun gear 103 respectively, via the first stage planetary gears 105 and the second stage planetary gears 107 respectively. The input stage ring gear 109 and the output stage ring 111 include a plurality of ring gear teeth positioned on an inner radial edge of the input stage ring gear 109 and the output stage ring gear 111. The input stage ring gear 109 and the output stage ring 111 include a ball bearing race 121 configured to house a ball bearing facilitating smooth rotation of the input stage ring gear 109 with respect to the output stage ring gear 111.

The motor 114, which includes, but is not limited to, a brushless outrunner motor having a motor shaft 113, is embedded in the input sun gear 101. The motor 114 engages the input sun gear 101 to rotatably actuate the input sung gear 101 and thereby cause the input sung gear 101 to rotate. Rotation of the input sun gear 101 causes the first stage planetary gears 105 and the second stage planetary gears 107 to rotate, which in turn cause the input stage ring gear 109 and the output stage ring gear 111 to rotate.

The input sun gear 101, the output sun gear 103, the input stage ring gear 109, the output stage ring gear 111, the plurality of first stage planetary gears 105, and the plurality of second stage planetary gears 107 all include end rollers fixed parallel and to every gear component and coaxial to their respective gear components. The end rollers permit the gear bearing drive 100 to be provided in a more compact form and to establish alignment of the gears in the longitudinal and lateral direction as well as engagement of the components. Specifically, the input sun gear 101 includes an arcuate sun gear roller 102 and the output sun gear 103 includes an arcuate sun gear roller 104. The arcuate sun gear roller 102 is parallel to the arcuate sun gear roller 104. The radius of curvature provided on the arcuate sun gear rollers 102 and 104 provide the rollers 102 and 104 with a conical radius. The arcuate sun gear roller 102 and the arcuate sun gear roller 104 are positioned axially outward of the sun gear teeth of the input sun gear 101 and the output sun gear 103. The arcuate sun gear roller 102 and the arcuate sun gear roller 104 include angular contact surfaces associated with the input sun gear 101 and the output sun gear 103 respectively. When the arcuate rollers are used on both sides of gear bearing drive 100, the planetary gear behaves as a 4-point contact bearing, which can support radial, thrust, and moment loads simultaneously. As discussed further herein, the diameter of the contact surfaces of the arcuate sun gear roller 102 and the arcuate sun gear roller 104 corresponds to the pitch diameter of the associated gear at the contact point.

The first stage planetary gear 105 includes an arcuate planetary gear roller 106 and the second stage planetary gear 107 includes an arcuate planetary gear roller 108. The arcuate planetary gear roller 106 is parallel to the arcuate planetary gear roller. The arcuate planetary gear roller 106 and the arcuate planetary gear roller 108 are positioned axially outward of the planetary gear teeth of the first stage planetary gear 105 and the second stage planetary gear 107. The arcuate planetary gear roller 106 and the arcuate planetary gear roller 108 include angular contact surfaces associated with the first stage planetary gear 105 and the second stage planetary gear 107 respectively. As discussed further herein, the diameter of the contact surfaces of the arcuate gear roller 106 and the arcuate planetary gear roller 108 corresponds to the pitch diameter of the associated planetary gear at the contact point.

The input stage ring gear 109 includes an arcuate ring roller 110 and the output stage ring gear 111 includes an arcuate ring roller 112. The arcuate ring roller 110 is parallel to the arcuate ring roller 112. The arcuate ring roller 110 and the arcuate ring roller 112 are positioned axially outward of the ring gear teeth of the input stage ring gear 109 and the output stage ring gear 111. The arcuate ring roller 110 and the arcuate ring roller 112 include angular contact surfaces associated with the input stage ring gear 109 and the output stage ring gear 111 respectively. The diameter of the contact surfaces of the arcuate ring roller 110 and the arcuate ring roller 112 corresponds to the pitch diameter of the associated ring gear at the contact point.

When used in a dual stage planetary gear box as implemented in the gear bearing drive 100, the rolling surfaces from the sun gears 101, 103, the planetary gears 105, 107, and the ring gears 109, 111 locate the planetary gears 105, 107 in their orbit but do not interfere with rotation of the planetary gears 105, 107, which is in accordance with pure rolling. The sun gears 101, 103, the planetary gears 105, 107, and the ring gears 109, 111 act to transfer the torque from the motor 114 and the arcuate rollers 102, 104, 106, 108, 110, 112 perform the bearing support function in the thrust or axial and radial directions. The arcuate rollers 102, 104, 106, 108, 110, 112 are annular and include smooth surfaces angled with respect to the face of their respective gears. The arcuate surface includes a curve extending axially from the face of the respective gears.

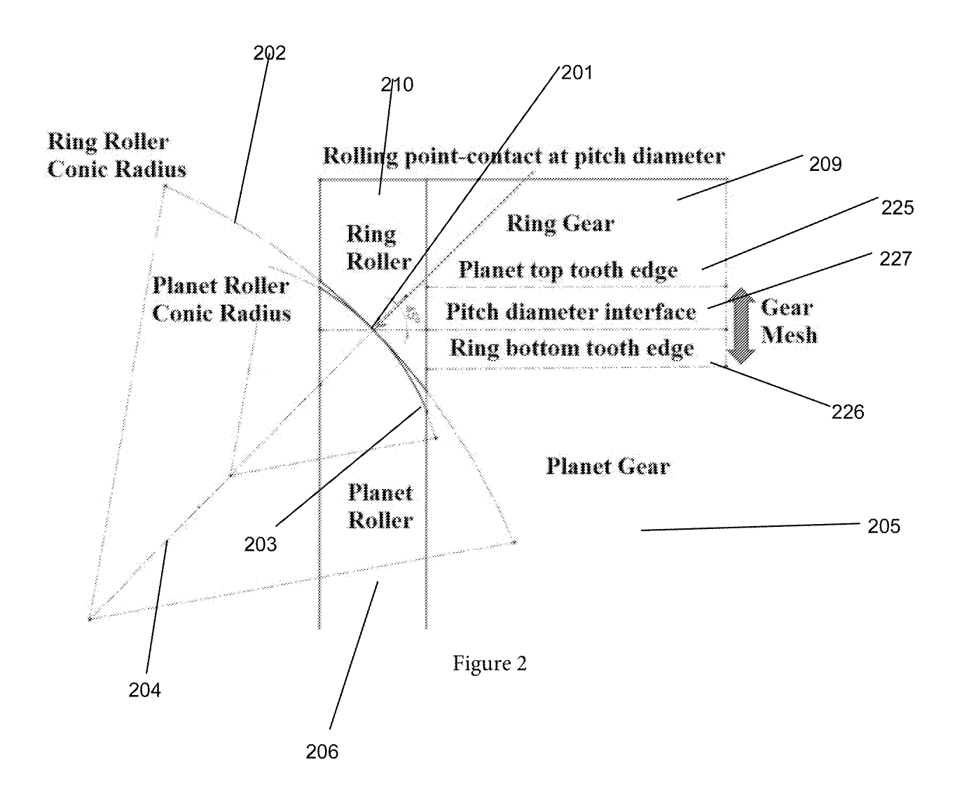

FIG. 2 is a schematic of the contact surfaces of a planetary gear set, in accordance with exemplary inventive embodiments. The arcuate rollers, according to example embodiments, may be formed as a curved surface. The arcuate contact surfaces may be modeled by two tangent circles 202 and 203 (or the arcs of two tangent circles) having parallel axes, where a rolling contact point 201 is at the intersection of a line 204 pass through the center of tangent circles 202 and 203. The arcuate planetary gear roller 206, coupled to an axial face of the planetary gear 205, includes an arcuate edge formed by a portion of the circle 203 and the ring gear roller 210, coupled to an axial face of the ring gear 209 includes an arcuate edge formed by a portion of the circle 202. The planetary gear 205 and the ring gear 209 gears mesh such that a pitch diameter interface 227 is positioned between a planetary gear top tooth edge 225 and a ring gear bottom tooth edge 226. The rolling contact point 201 avoids slip and friction, and improves the overall efficiency of a gear set formed by the planetary gear 205 and the ring gear 209 including planetary roller 206 and ring gear roller 210 respectively. The arcuate rollers, including the arcuate planetary gear rollers, the ring gear rollers, and the sun gear rollers as described herein while demonstrated in example embodiments showing two stage (or dual stage) planetary gear sets and two stage planetary gear bearing drives may be implemented with single stage, dual stage, 3 stage, or other multi-stage planetary gear sets.

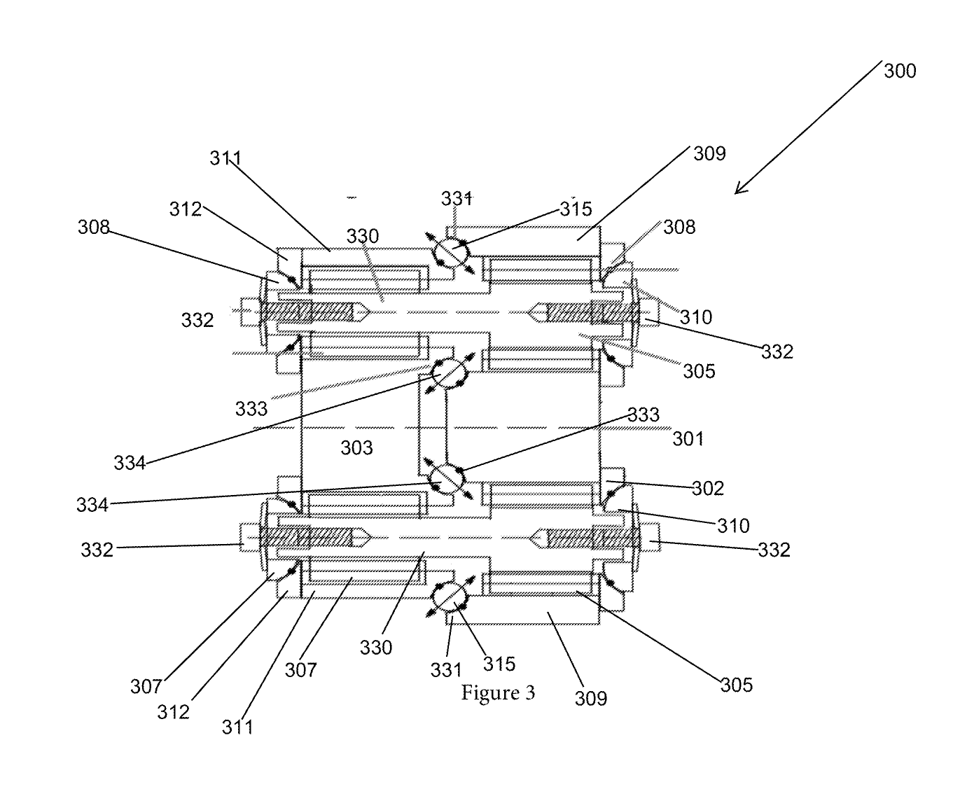

FIG. 3 is a cross sectional schematic of a two stage planetary gear set, in accordance with exemplary inventive embodiments. A two stage planetary gear set 300 includes an input sun gear 301 coupled to an output sun gear 303 by stage one planetary gears 305 and stage two planetary gears 307. The input sun gear 301 and the output sun gear 303 forms an integrated sun gear raceway 333 between one another for receipt of a ball bearing 334 to allow sun gears to freely rotate with respect to one another. The stage one planetary gears 305 and the stage two planetary gears 307 are positioned in input ring gear 309 and output ring gear 310. The stage one planetary gears 305 and the stage two planetary gears 307 are configured to rotate in the input ring gear 309 and the output ring gear 310 in response to actuation or rotation of the input sun gear 301 to cause the output sun gear 303 to rotate. The input ring gear 309 and the output ring gear 311 form an integrated ring gear raceway 331 between one another for receipt of a ball bearing 315 to allow sun gears to freely rotate with respect to one another.

As demonstrated in FIG. 3, the stage two planetary gears 307 are coupled to the stage one planetary gears 305 via planet couplers 330. The stage two planetary gears 307 have different pitch diameters than the stage one planetary gears 305 such that they rotate about the same axis at different rotational speeds. The stage one planetary gears 305 include arcuate roller surface caps 310 coupled to an axial face of the stage one planetary gears 305 via bolts 332. Similarly, the stage two planetary gears 307 include arcuate roller surface caps 308 coupled to an axial face of the stage two planetary gears 307 via bolts 332. The arcuate roller surface caps 310 engage arcuate sun gear roller surface caps 302. The radius of curvature (in the radial direction) of the arcuate roller surface caps 310 and the arcuate sun gear roller surface caps 302 are distinct as demonstrated in FIG. 2 to form a contact point between the roller surface caps 302 and 310. The arcuate roller surface caps 310 also engage arcuate ring gear roller surface caps 315. The radius of curvature of the arcuate ring gear roller surface caps 315 and the arcuate sun gear roller surface caps 302 may be the same in example embodiments. The stage two planetary gears 307 include arcuate roller surface caps 308 coupled to an axial face of the stage one planetary gears 307 via bolts 332. The arcuate roller surface caps 308 engage arcuate sun gear roller surface caps 304 of the output sun gear 303. The arcuate roller surface caps 308 also engage arcuate ring gear roller surface caps 332 of the output ring gear 311.

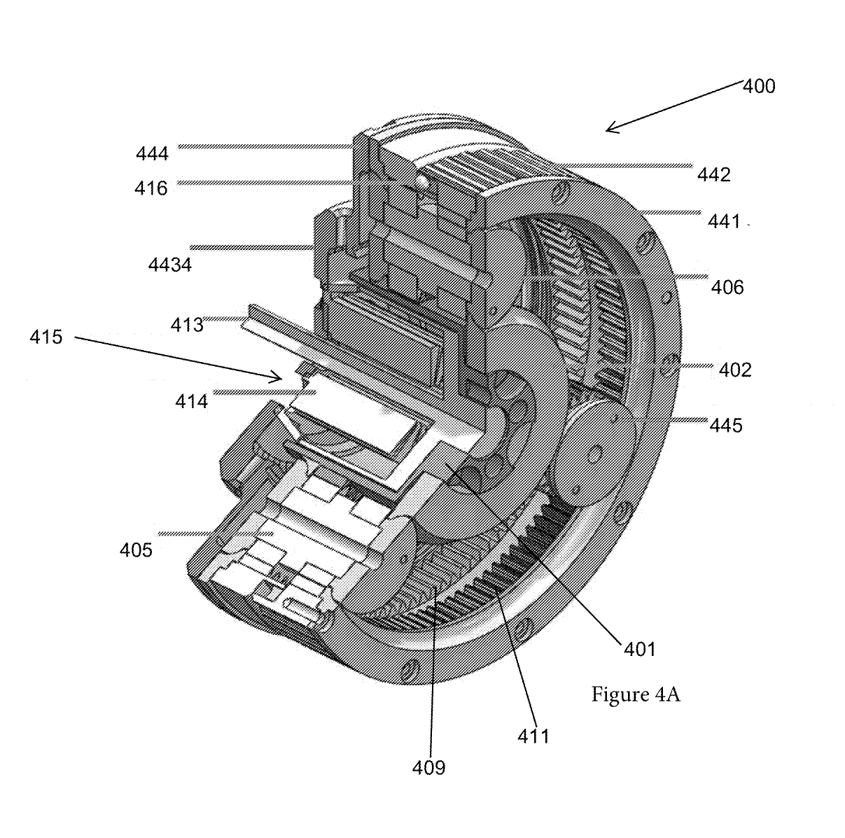

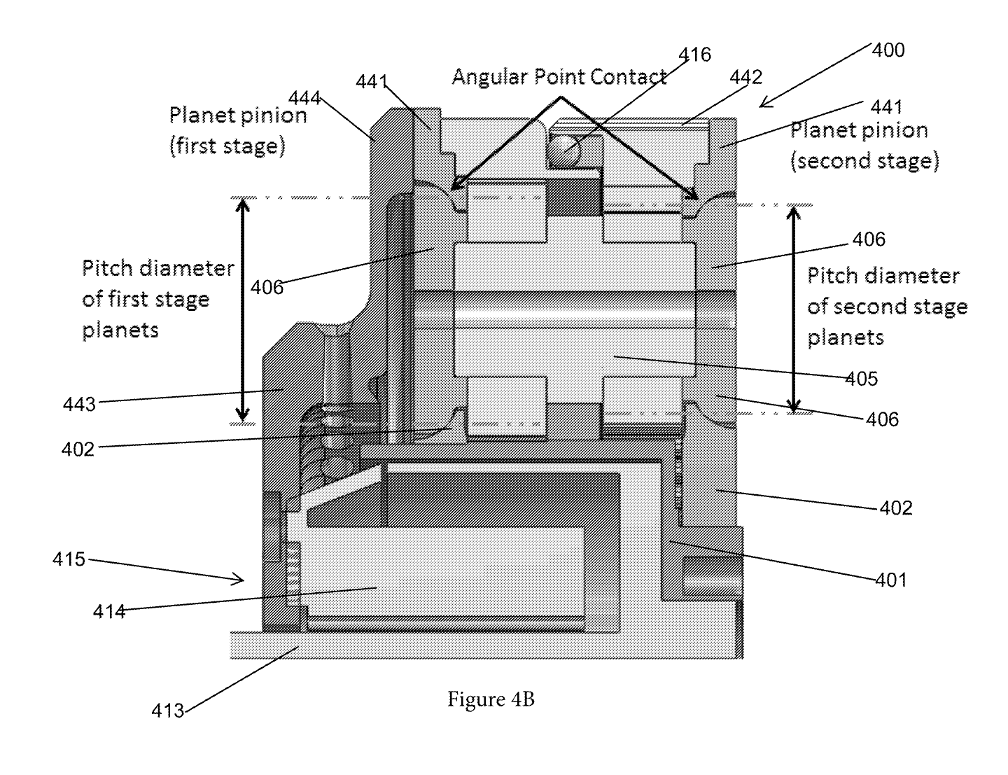

FIGS. 4A and 4B are cross sectional views of a planetary gear bearing drive, of a two stage planetary gear set, in accordance with exemplary inventive embodiments. FIG. 4A is partial cross section perspective view of a planetary gear bearing drive 400 and FIG. 4B is a cross sectional end view of the planetary gear bearing drive 400. The planetary gear bearing drive 400, include a plurality of planetary gears 405, surrounding a sun gear 401 and position in a ring gear 409. An external rotor motor 415 is integrated within the sun gear 401. The external rotor motor 415 includes motor stator coils 414 and motor rotor shaft 413. In example embodiments the planetary gear bearing drive 400 includes one or more sensors including, but not limited to, a compliant torque sensor module. The planetary gear bearing drive 400 may be composed of a range of materials including, but not limited to, plastic, metal, or a combination of materials. For example, the gears and/or rollers are composed of materials, which may include, but are not limited to, molded nylon in particular embodiments. In example embodiments, the gears and rollers are manufactured by injection molding plastic. The gear bearing drive 400 includes a mounting base 444 for mounting the drive to a support structure. The gear bearing drive 400 includes an encode mount 443. The gear bearing drive 400 includes thrust bearings 416. The gear bearing drive 400 is configured for output via output shaft drive 441 and/or output belt drive 442. The output shaft drive 441 also incorporates arcuate ring roller, configured to engage planet roller 406 which also engages sun roller 402. The planet roller 406 is coupled to the planetary gear 405 via alignment pins 445.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A gear set assembly comprising:
a ring gear including a plurality of ring gear teeth on an inner radial edge of the ring gear, the ring gear including a first arcuate ring roller and a second arcuate ring roller, the first arcuate ring roller and the second arcuate ring roller positioned axially outward of the ring gear teeth on opposite lateral sides of the ring gear;
a sun gear having a plurality of sun gear teeth positioned about an outer radial sun gear edge, the sun gear including a first arcuate sun gear roller and a second arcuate sun gear roller, the first arcuate sun gear roller and the second arcuate sun gear roller positioned axially outward of the sun gear teeth on opposite lateral sides of the sun gear; and
a planetary gear positioned in the ring gear between the sun gear and the ring gear, the planetary gear including a plurality of planetary gear teeth positioned about an outer radial planetary gear edge, the plurality of planetary gear teeth engaging the sun gear teeth and the ring gear teeth, the planetary gear including a first arcuate planetary gear roller and a second arcuate planetary gear roller, the first arcuate planetary gear roller and the second arcuate planetary gear roller positioned axially outward of the planetary gear teeth on opposite lateral sides of the planetary gear, the first arcuate planetary gear roller engaging the first arcuate ring roller and the first arcuate sun gear roller and the second arcuate planetary gear roller engaging the second arcuate ring roller and the second arcuate sun gear roller.

2. The gear set assembly according to claim 1, wherein the arcuate ring roller has a ring roller radius that is larger than the arcuate planetary gear roller.

3. The gear set assembly according to claim 1, wherein the planetary gear includes a first planetary gear and further comprising a second planetary gear.

4. The gear set assembly according to claim 1, further comprising a compliant torque sensor coupled to the gear set assembly and configured to measure torque applied to one or more gears.

5. The gear set assembly according to claim 1, further comprising a motor coupled to the sun gear.

6. The gear set assembly according to claim 1, wherein the first and second arcuate ring rollers are integrally formed with the ring gear, the first and second arcuate sun gear rollers are integrally formed with the sun gear, and the first and second planetary gear rollers are integrally formed with the planetary gear.

7. The gear set assembly according to claim 1, wherein the first and second arcuate ring rollers, the first and second arcuate sun gear rollers, and the first and second planetary gear rollers are parallel to another.

8. A gear set assembly comprising:
a ring gear including a plurality of ring gear teeth on an inner radial edge of the ring gear, the ring gear including an arcuate ring roller positioned axially outward of the ring gear teeth;
a sun gear having a plurality of sun gear teeth positioned about an outer radial sun gear edge, the sun gear including an arcuate sun gear roller positioned axially outward of the sun gear teeth; and
a planetary gear positioned in the ring gear between the sun gear and the ring gear, the planetary gear including a plurality of planetary gear teeth positioned about an outer radial planetary gear edge, the plurality of planetary gear teeth engaging the sun gear teeth and the ring gear teeth, the planetary gear including an arcuate planetary gear roller positioned axially outward of the planetary gear teeth, the arcuate planetary gear roller engaging the arcuate ring roller and the arcuate sun gear roller.

9. The gear set assembly according to claim 8, further comprising a motor coupled to the sun gear.

10. The gear set assembly according to claim 8, further comprising a compliant torque sensor coupled to the gear set assembly and configured to measure torque applied to one or more gears.

11. A method of forming a gear set comprising:
coupling an arcuate ring roller to a ring gear, the ring gear including a plurality of ring gear teeth on an inner radial edge of the ring gear, the arcuate ring roller positioned axially outward of the ring gear teeth;
coupling an arcuate sun gear roller to a sun gear, the sun gear having a plurality of sun gear teeth positioned about an outer radial sun gear edge, the arcuate sun gear roller positioned axially outward of the sun gear teeth;
coupling an arcuate planetary gear roller to a planetary gear, the planetary gear including a plurality of planetary gear teeth positioned about an outer radial planetary gear edge, the arcuate planetary gear roller positioned axially outward of the planetary gear teeth; and
coupling the sun gear to the ring gear via the planetary gear, the planetary gear positioned in the ring gear between the sun gear and the ring gear, the plurality of planetary gear teeth engaging the sun gear teeth and the ring gear teeth, the arcuate planetary gear roller engaging the arcuate ring roller and the arcuate sun gear roller.

12. The method according to claim 11, wherein the ring gear includes a first ring gear, wherein the sun gear includes a first sun gear, wherein the plurality of planetary gears includes a first plurality of planetary gears, wherein the method further comprises:
coupling a second ring gear to the first ring gear;
coupling a second sun gear to the first sun gear; and
coupling a second plurality of planetary gears to the first plurality of planetary gears so as to form a two stage planetary gear set.

13. The method according to claim 12, further comprising positioning a first ball bearing in a ball bearing race between the first ring gear and the second ring gear.

14. The method according to claim 12, further comprising positioning a first ball bearing in a ball bearing race between the first sun gear and the second sun gear.

15. The method according to claim 11, further comprising coupling a motor to the sun gear.

16. The method according to claim 11, further comprising coupling a compliant torque sensor to the gear set assembly the compliant torque sensor configured to measure a torque applied to one or more gears.

17. A method of forming a gear set comprising:
coupling a sun gear to a ring gear via a plurality of planetary gears, the plurality of planetary gears positioned between the sun gear and the ring gear, the plurality of planetary gears engaging the sun gear and the ring gear;
coupling a first arcuate ring roller and a second arcuate ring roller to the ring gear on a first ring gear axial face and second ring gear axial face respectively;
coupling a first arcuate sun gear roller and a second arcuate sun gear roller to the sun gear on a first sun gear axial face and a second sun gear axial face respectively; and
after the first arcuate ring roller and the second arcuate ring roller are coupled to the ring gear and after the first arcuate sun gear roller and the second arcuate sun gear roller are coupled to the sun gear, coupling the plurality of first arcuate planetary rollers and the plurality of second arcuate planetary rollers to the plurality of planetary gears on a first planetary gear axial face of each planetary gear in the plurality of planetary gears and on a second planetary gear axial face of each planetary gear in the plurality of planetary gears.

18. The method according to claim 15, wherein the first arcuate ring roller, the second arcuate ring roller, the first arcuate sun gear roller, and the second arcuate sun gear roller have a radial ring roller radius that is larger than the plurality of first arcuate planetary rollers and the plurality of second arcuate planetary rollers.

19. The method according to claim 17, further comprising coupling a motor to the sun gear.

20. The method according to claim 17, further comprising coupling a compliant torque sensor to the gear set assembly the compliant torque sensor configured to measure a torque applied to one or more gears.

21. The method according to claim 17, wherein the ring gear includes a first ring gear, wherein the sun gear includes a first sun gear, wherein the plurality of planetary gears includes a first plurality of planetary gears, wherein the method further comprises:
coupling a second ring gear to the first ring gear;
coupling a second sun gear to the first sun gear; and
coupling a second plurality of planetary gears to the first plurality of planetary gears so as to form a two stage planetary gear set.
